(19) United States
(12) Patent Application Publication
(10) Pub. No.: US 2015/0331553 A1
(43) Pub. Date: Nov. 19, 2015

(54) METHOD AND SYSTEM FOR ANALYZING THE LEVEL OF USER ENGAGEMENT WITHIN AN ELECTRONIC DOCUMENT

(71) Applicant: FABTALE PRODUCTIONS PTY LTD, Main Beach, Queensland (AU)

(72) Inventor: Frank J. SHAFFER, Queensland (AU)

(21) Appl. No.: 14/758,074

(22) PCT Filed: Dec. 23, 2013
(86) PCT No.: PCT/IB2013/061260

§ 371 Date: Jun. 26, 2015

Related U.S. Application Data
(60) Provisional application No. 61/746,774, filed on Dec. 28, 2012.

(51) Int. Cl. G06F 3/0481; G06F 17/24; H04L 29/08; G06F 17/21

(52) U.S. Cl. CPC G06F 3/0481; G06F 17/212; G06F 17/243; H04L 67/02

(57) ABSTRACT

A method for analysing the level of user engagement within an electronic document is provided. The method includes displaying an electronic document having one or more pages to a user. The document includes a graphical user interface and one or more content placeholders associated with the pages for displaying content within the placeholder. The method further includes the steps of determining whether the user has carried out one or more actions within the electronic document and determining the level of user engagement based on the one or more actions.

### TECHNICAL FIELD

The present invention relates to a method and system for analysing the level of user engagement within an electronic document.

### BACKGROUND

Electronic documents such as e-books provide a digital equivalent of a printed document, and may be displayed and read on computers and hand held devices including mobile telephones, PDAs and dedicated e-book readers. In recent times, use of electronic documents has increased and audio and video together with text have been used to enhance a user's experience in reading the document.

Video, audio, text, and image content alone can be considered static or composed of a single linear file. There exist techniques to determine if a file has been opened or viewed. A problem with these existing techniques is that they are very limited in measuring to what degree users engage with the content.

For example, many user uploaded video sites only analyse the number of views and average viewing time. A problem with this approach is that it is only a modest improvement from a television commercial in that the site is unable to determine whether the viewer has in fact left the room or is viewing another device such as a tablet or phone.

Accordingly, it would be desirable to provide a system and method for improved analysis of user engagement with an electronic document.

A reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY OF THE INVENTION

In a broad form, the present invention provides a method for analysing the level of user engagement within an electronic document, wherein content placeholders are provided, and it is thereby possible to determine the user's actions on the respective pages and media, so that a level of user engagement can be determined. According to one aspect, the present invention provides a method for automatically analysing the level of user engagement within an electronic document, including the steps of:
displaying an electronic document having one or more pages, the document including a graphical user interface and one or more content placeholders associated with the pages for displaying content within the placeholder;
   determining whether the user has carried out one or more actions within the electronic document; and responsive to the one or more actions, automatically determining the level of user engagement

Advantageously, the present invention allows for measuring audience engagement through a multiplicity of media within the content placeholders rather than a linear video file in isolation. Since each page is broken down into a variety of images, text, links, video, and sounds each with their own subset of analytics; the resulting metric analysis is far greater and nuanced than any one medium by itself. These enhanced analytics in real time also empower the creator to iterate their message with more accuracy, personalization, effectiveness, and speed.

According to another aspect, the present invention provides software for use with a computer including a processor and associated memory device for storing the software is provided, the software being for providing an electronic document to a user, the electronic document having one or more pages and one or more content placeholders associated with the pages, the software including a series of instructions to cause the processor to carry out the steps of: displaying an electronic document having one or more pages, the document including a graphical user interface and one or more content placeholders associated with the pages for displaying content within the placeholder; determining whether the user has carried out one or more actions within the electronic document; determining the level of user engagement based on the one or more actions.

According to a further aspect, the present invention provides a computer readable media containing software for use with a computer including a processor and associated memory device for storing the software is provided, the software being for providing an electronic document to a user, the electronic document having one or more pages and one or more content placeholders associated with the pages, the software including a series of instructions to cause the processor to carry out the steps of: displaying an electronic document having one or more pages, the document including a graphical user interface and one or more content placeholders associated with the pages for displaying content within the placeholder; determining whether the user has carried out one or more actions within the electronic document; determining the level of user engagement based on the one or more actions.

According to another aspect, the present invention provides an apparatus for providing an electronic document to a user is provided, the electronic document having one or more pages and one or more content placeholders associated with the pages, the apparatus including: (i) a processor, (ii) a memory, (iii) a user interface including an input device and an output device, and (iv) a software program resident in memory accessible to the processor, the program executable by the processor to carry out the steps of: displaying an electronic document having one or more pages, the document including a graphical user interface and one or more content placeholders associated with the pages for displaying content within the placeholder; determining whether the user has carried out one or more actions within the electronic document; determining the level of user engagement based on the one or more actions.

The apparatus, for example, may include an electronic book reader, a PDA, mobile phone, computer or other device.

Accordingly, implementations of the present invention allow for the provider of the electronic document to better understand the usage and actions taken by a user within the document, and to measure the level of engagement with the document and with sections of the document. This in turn provides a mechanism by which the provider can, for example, change aspects of the document and determine whether user engagement has improved, or to identify aspects that or poorly used by users.

Embodiments of the present invention will now be described, by way of example only, with reference to the accompanying drawings. It is to be understood that the particularity of the drawings does not supersede the generality of the preceding description of the invention.

### BRIEF DESCRIPTION OF THE DRAWINGS

FIG. 1 is a schematic diagram of an example network that can be utilised to give effect to a method according to an embodiment of the invention.

FIG. 2 is a functional block diagram of an example processing system that can be connected to the network.

FIG. 2a is a schematic diagram of a preferred network that can be utilised to give effect to a method according to an embodiment of the invention.

FIGS. 3a-3e show an example sequence of screen shots of a page of an electronic document being displayed according to an embodiment of the invention.

FIG. 4 is a flow chart of a method for analysing the level of user engagement within an electronic document according to an embodiment of the invention.

FIGS. 5a-5g show example screen shots of analytics which determine the level of user engagement in the electronic document.

### DETAILED DESCRIPTION

The present invention may be implemented in a wide variety of ways, using networks which are local or limited, private networks, or the public internet or similar systems. It is further capable of being implemented in many differences systems, in various software languages and using a wide variety of different hardware. The present invention may further be part of aa larger system and interact with one or more of he software and/or hardware products. Accordingly, the example should be understood as illustrative and not limitative of the general inventive concept.

The term electronic document is intended to encompass any readable file which can be displayed for interaction with a user. The files may be presented via, for example, the public internet or an intranet. They may encompass different types of media, as will be explained below. They may be stored in non-electronic means, for example in optical or or any other storage means, for presentation as required. The document in some implementations may be presented as a webpage, using HTML or similar hypertext enabled languages.

### Example of a Network

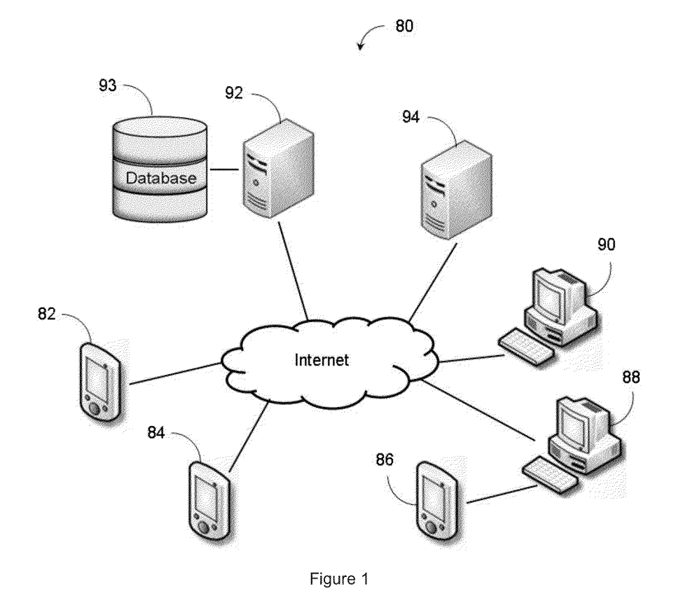

Embodiments of the present invention can be realised over a network, an example of which is shown in FIG. 1.

FIG. 1 illustrates an example of a network for use with implementations of the present invention. Network 80 includes one or more client processing systems and one or more server processing systems. In this example, the client processing systems include electronic book readers 82, 84, 86 and personal computers (PCs) 88, 90. The server processing systems include network servers 92 and 94. The client and server processing systems 82, 84, 88, 90 and 94 may be connected via a network such as the internet 96 and the electronic book reader 86 may be connected to a PC 88.

The transfer of information and/or data over the network can be achieved using wired communications means or wireless communications means. The server processing systems 92 and 94 can facilitate the transfer of data between the network and one or more databases, such as database 93.

It will be appreciated that embodiments of the invention may be realised over different networks, such as a MAN (metropolitan area network), WAN (wide area network) or LAN (local area network). Also, embodiments need not take place over a network, and the method steps could occur entirely on a client or server processing system.

### Example of a Processing System

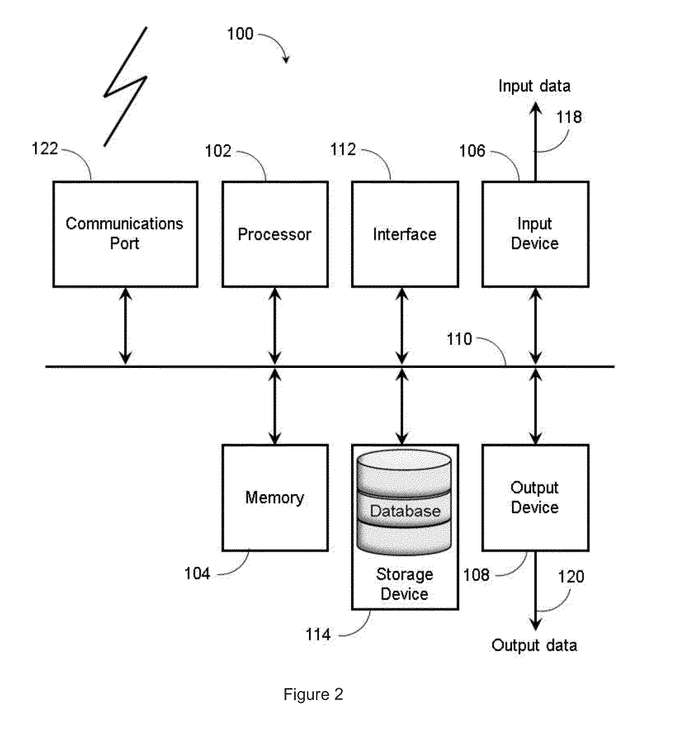

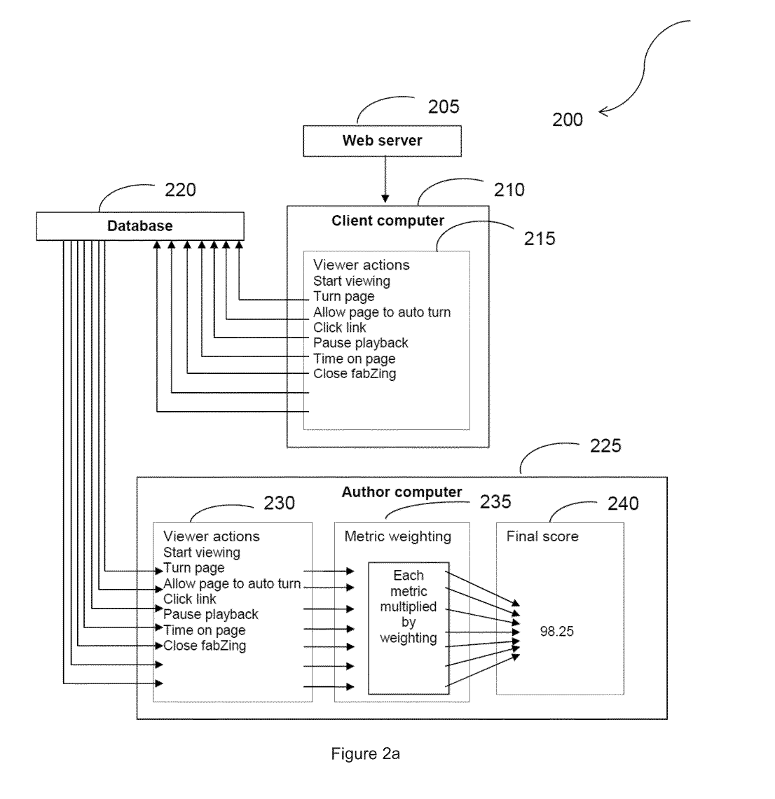

The client and server processing systems 82-94 may include a processing system 100 shown in FIG. 2.

The processing system 100 includes a processor 102 (or processing unit), a memory 104, at least one input device 106, at least one output device 108 and a communications port 122. As is shown, the processor 102, memory 104, input device 106, output device 108 and communications port 122 are typically coupled together via a bus or group of buses 110. In certain embodiments, input device 106 and output device 108 may be the same device such as in the case of, for example, a computer graphics display or handheld device such as an electronic reader that incorporates a touch-screen. The input device may also include a keypad, movement sensor, retina scan (to detect movement of the eye), a camera or sensor to detect blinks to capture one or more actions carried out by the user of the system 100. Any kind of suitable input device may be used.

An interface 112 can also be provided for coupling the processing system 100 to one or more peripheral devices. For example interface 112 may include a PCI card or PC card. At least one storage device 114 which houses at least one database 116 can also be provided.

The memory 104 may include any suitable memory device and including, for example, volatile or non-volatile memory, solid state storage devices, magnetic devices, etc. The memory 104 may typically store an operating system that provides functionality to the processing system 100. A file system and files are also typically stored on the storage device 114 and/or the memory 104. The memory 104 may also include one or more software applications or program data.

The applications running in memory 104 may include electronic document presentation programs, such as Impress™, PowerPoint™, Flash™, Silverlight™, Keynoter™, Acrobat™, Mobipocket™, Sprocketcore™, Stanza™, HTML, JavaScript or any other suitable application for displaying electronic documents for reading or reviewing.

The processor 102 may include more than one processing device, for example to handle different functions within the processing system 100.

Input device 106 receives input data 118 and may include, for example, a keyboard, a pointer device such as a pen-like device or a mouse, a tracker-ball, joystick or touch-screen, audio receiving device for voice controlled activation, such as a microphone, data receiver or antenna such as a modem or wireless data adaptor, data acquisition card, etcetera. The input device may also include a movement detector or retina scan (to detect eye movement), a sensor or camera to detect blinks, or any other suitable input device. Advantageously, the system, via the input device 106 can detect actions from the user to ultimately determine the level of engagement of a user with the electronic document. The input device 108 may be operable by a user to enter input data 118, or it may receive data from another input data source or the system may capture data from the input device to determine if an action has occurred. Thus, the input data 118 may be provided by different input devices 106. For example, in an embodiment the input data 18 may include keyboard or mouse instructions entered by a user, in conjunction with data received via a network. Preferably, the input device 108 includes a touch screen associated with an electronic reader.

Output device 108 produces or generates output data 120. In one embodiment, the output device 108 includes a display device (such as a computer graphics display) for providing output data 120 in a visual form. In another embodiment, the output device 108 includes a display device or monitor together with a set of audio speakers in which case the output data 120 may be provided in an audio-visual form. Advantageously, the present invention allows for a determination as to whether a user has listened to a portion of the electronic document via receiving input from a microphone for example. A sound produced by the viewer could be recorded such as a clap to indicate that they have listened to a portion of the document. Alternatively, the viewer may be required to a tick box or provide a textual response to a question prompt which does not appear until a later stage of the song, audio, page, video, etcetera. Preferably, these prompts are visible for a limited period of time (such as in the middle of media playback to assess viewer attention). For example, after each of the choreographed media appears, dissolves, slides into document over a number of different pages and times, the viewer is asked (or has been instructed) and has a limited timeframe to tap every image, text box, and video within the overall document to verify their presence and engagement. A reward or point system allowing viewer to gauge their own engagement may be provided.

It will be appreciated that other types of output devices 108 may also be used, such as, a port (for example a USB port), a peripheral component adaptor, a data transmitter or antenna such as a modem or wireless network adaptor, etcetera.

It will also be appreciated that the output data 120 could be output from a variety of different output devices 108 such as, for example, a visual display on a monitor in conjunction with data transmitted to a network. In such an embodiment a user may view data output, or an interpretation of the data output, on, for example, a monitor or using a printer.

The storage device 114 can include any form of data or information storage means, for example, volatile or non-volatile memory, solid state storage devices, optical devices, magnetic devices, or the like.

The communications port 122 allows the processing system 100 to communicate with other devices via a hard wired or wireless network, such as network 80.

In use, the processing system 100 can be adapted to allow data or information to be stored in and/or retrieved from, via wired or wireless communication means, the at least one database 116. The interface 112 may allow wired and/or wireless communication between the processing unit 102 and peripheral components that may serve a specialized purpose. The processor 102 may receive instructions as input data 118 via input device 106 and can display processed results or other output to a user by utilising output device 108. Multiple input devices 106 and/or output devices 108 can be provided.

In terms of the processing system 100, it should be appreciated that the processing system 100 may be any form of terminal, server processing system, specialised hardware, computer, computer system or computerised device, personal computer (PC), mobile or cellular telephone, mobile data terminal, portable computer, Personal Digital Assistant (PDA), pager or any other similar type of device.

FIG. 2a is a schematic diagram of a preferred network that can be utilised to give effect to a method according to an embodiment of the invention. The network 200 includes a web server 205 which may be connected to the Internet and web server 205 is connected to a client computer 210. Client computer 210 includes a viewer action component 215 which determines one or more viewer actions when an electronic document is being read or viewed by a viewer for example: start viewing, turn page, allow page to auto turn, click link, pause play back, time on page, close the document.

Client computer 210 and viewer action component 215 are connected to database 220 which stores the output of the viewer action component 215. Also connected to database 220 is author computer 225. Author computer 225 receives input from database 220 in the form of data from client computer 210 by way of viewer action component 215. Author computer 225 includes viewer action component 230 which determines one or more actions carried out by the viewer which were received from the database 220 and passes this information to a metric weighting component 235. The metric weighting component 235 operates by applying a weighting to one or more actions and depending on whether or not the document being viewed is being viewed by one person or by many people. The metric weighting component 235 then outputs the result to final score component 240 which provides the author computer 225 with a final score as to the level of engagement that the person using the client computer 210 had with the electronic document.

An example of weighting may refer to a warning label on a prescribed medicine. The effectiveness and engagement of the label would be enhanced by outputting such information in a multi modal format rather than static text although in this case the company may not consider there to be any benefit to sharing via social media. Consequently an emphasis on completing the viewing while answering a time delayed question would receive a more valued scoring. For example using a scale of 1 to 100; reaching the last page would have a 25% weighting, inputting appropriate answers a 55% weighting, clicking on time delayed ‘I understand’ buttons a 15% weighting, and ‘comments’ or further information links only a 5% weighting. This would be a one to many form of communication designed to increase understanding and reduce adverse medical outcomes while also diminishing a drug company's liability by documenting a user's engagement far beyond what is currently available.

Conversely, the engagement measurement for a coupon or advertisement would vary greatly from a warning label or instruction manual. In this case, a ‘like’ or the initiation of a product purchase would be a more important consideration. Using again a scale of 1 to 100; clicking on a ‘buy now’ button and completing the purchase would have a 56% weighting; sharing via social media a 19% weighting; ‘liking’ the brand a 10% weighting; reaching the last page a 4% weighting, clicking on a link for ‘further information’ a 3% weighting; inputting a comment a 2% weighting; visiting the brand's website or Facebook™ page a 6% weighting.

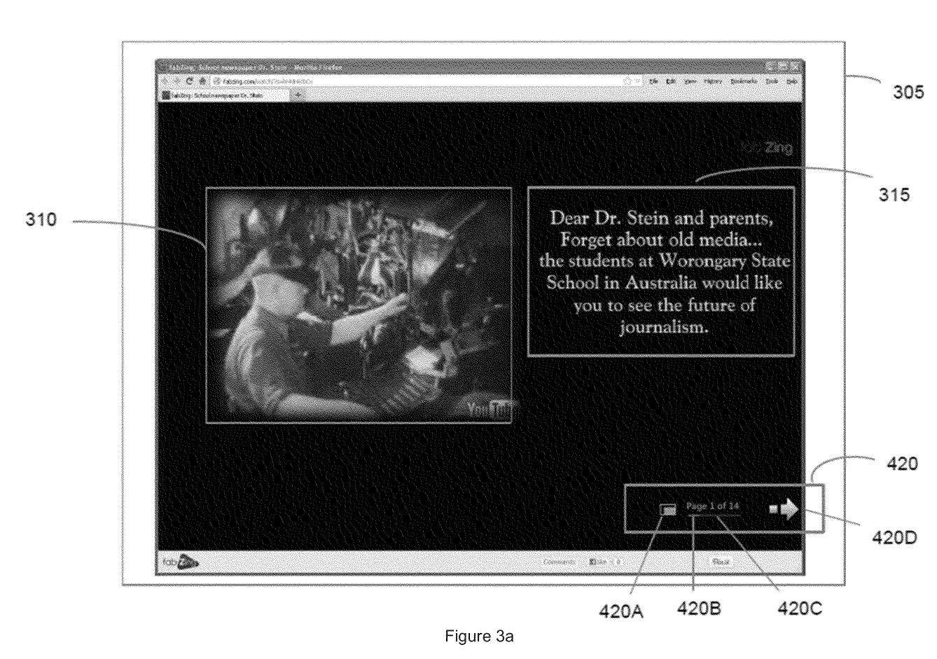

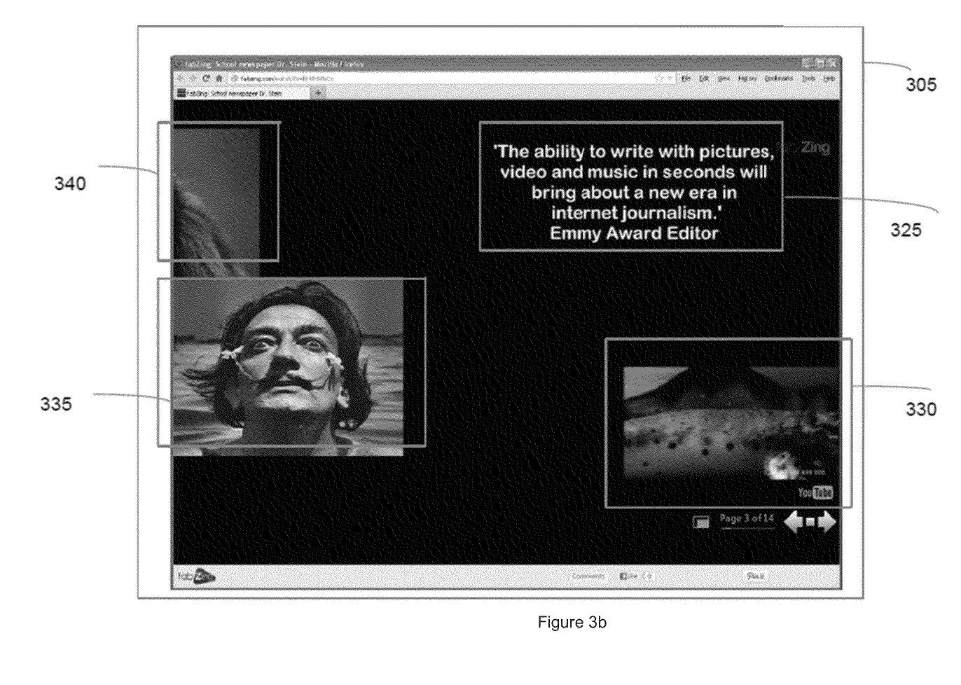

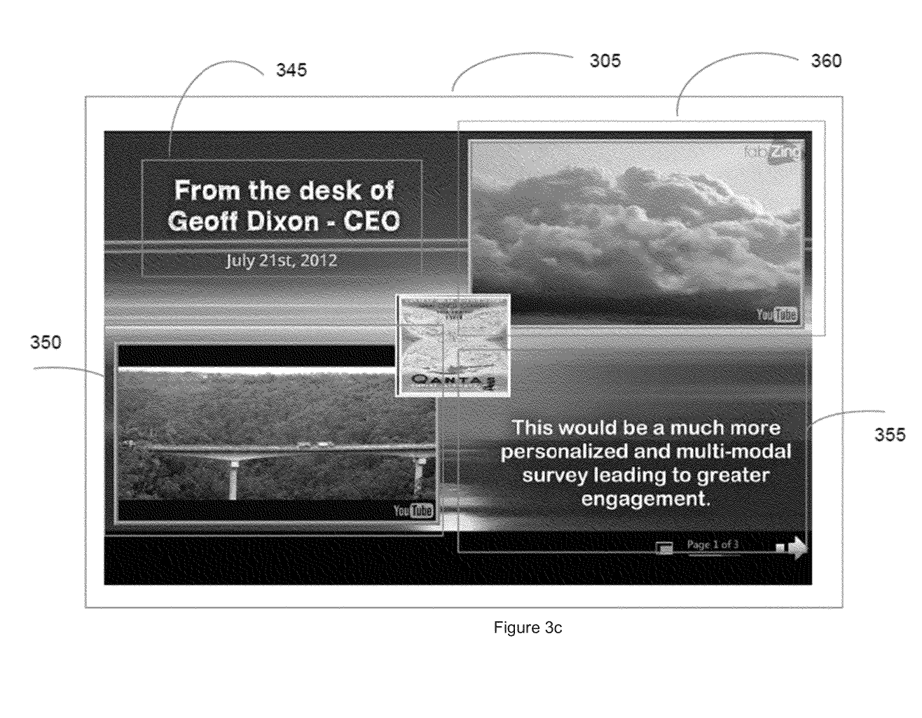

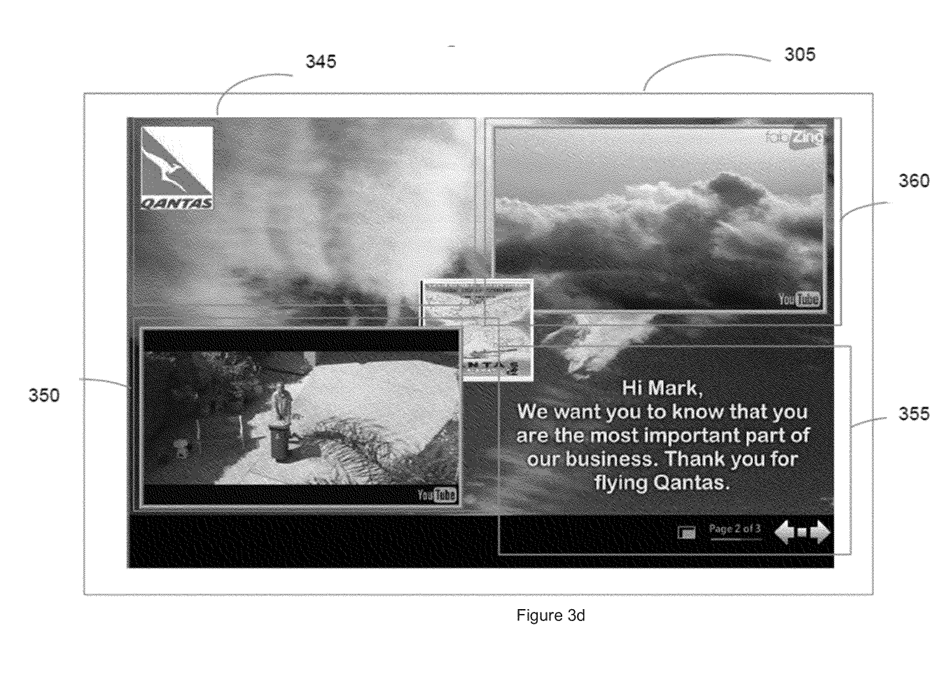

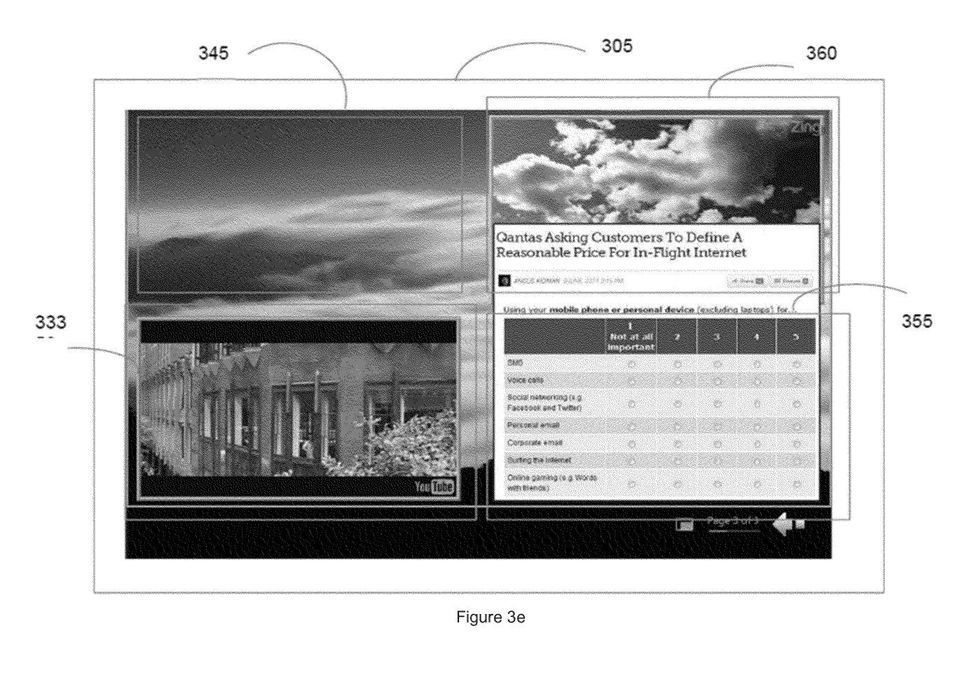

A method for analysing the level of engagement of a user within an electronic document will be described with reference to FIGS. 3 to 5. In this example, the electronic document is a newspaper style document shown in the screenshots FIGS. 3a and 3b and includes 14 pages and multiple content placeholders associated with the pages. This example is given for illustrative purposes only, and the electronic document may be any story, presentation, advertisement, lesson plan, company brochure, invitation, office communication, instruction manual, warning label, business card, coupon, ticket, boarding pass, virtual good (e.g., flowers, coffee) etcetera. It will be appreciated that the electronic document may be downloaded by the user, for example to the electronic book reader 82, it may have been copied to the reader 82 from a computer readable medium, such as a DVD or USB device or it may be pre-installed on the reader 82 when purchased. The electronic document may thus be saved in memory 104 of the reader 82.

Also saved in memory 104 of the reader 82 is software for carrying out the method according to an embodiment of the present invention. The software may also be downloaded to the reader 82 via the internet 96 or installed from a computer readable medium. The software may be usable with multiple different electronic documents, for example documents created by different authors.

In another embodiment, the software may be saved in memory 104 of an external server, for example server 92 and accessed by the reader 82 over the internet 96, via its communication port 122.

The electronic document may contain text, it may contain a video/audio recording of the document being read, or it may contain a combination of both. Content such as images, backgrounds, smells, animations, music, sounds and photographs are shown at different content placeholders in the electronic document. Some content placeholders may contain no content.

The user may browse through the pages of the electronic document and engage with it. The software causes the electronic document to be displayed on an output device 108, such as a display screen. The user may navigate through the document by using an input device 106, such as a touch screen on the reader 82 to turn the page, or the software may cause the next page to be displayed automatically once all the content on the previous page has been displayed.

Each page may include one or more content placeholders. For example, in FIG. 3a, page 1 has three content placeholders 305, 310 and 315, and a navigation bar 320. Content placeholder 305 defines the overall page in which a background maybe inserted and other content placeholders (such as 310 and 315) may be provided within it. Content placeholder 310 for example defines video in the middle left of page 1, which may fade in or play a short time after the content in content placeholder 310 appears. Content placeholder 315 defines a text box positioned in the middle right of the page. Navigation bar 320 includes a full screen option 320A, a page completion indicator 310B, a page number indicator 310C and a page turn button 310D. It would be desirable to determine to what extent the user has engaged with this page and the overall electronic document. For example, determining if the user selected the navigation bar 320 before content placeholders 310 and 315 finished displaying (as indicated by page indicator 320C).

Page 3 as shown in FIG. 3b includes five content placeholders 305, 325, 330, 335 and 340 together with navigation bar 320. Again, content placeholder 305 may define the overall page in which a background maybe inserted and other content placeholders (such as 325, 330, 335 and 340) may be provided within it. Content placeholder 325 defines text in the upper right of page 3, which may fade in or play a short time after the content in content placeholder 325 appears. Content placeholder 330 for example defines video in the lower right of page 3, which may fade in or play a short time after the content in content placeholder 325 appears may play across a number of pages (such as pages 3 to 6 for example). Content placeholder 325 for example defines an image in the lower left of page 3, which may fade in or move after the content in content placeholder 335 appears. Content placeholder 340 defines text in the upper left of page 3, which may transition from left to right. Again, navigation bar 320 includes a full screen option 320A, a page completion indicator 310b, a page number indicator 310c and a page turn button 310D.

FIGS. 3c, 3d and 3e show an electronic document in the form of advertising which consists of three pages and which includes a number of content place holders. In particular, the advertising relates to a survey which the author wishes the user(s) to carry out. FIG. 3c shows page 1 of 3 of the electronic document and it includes five content place holders 305, 345, 350, 355 and 360. In this case content place holders 345 and 355 are text whereas content place holders 350 and 360 are video. This page provides an introduction before moving to the second page shown in FIG. 3d, again including content place holders 305, 345, 350, 355 and 360 but in this case the content place holder 345 includes a picture and content place holder 355 includes a personalised greeting in anticipation of the user completing the survey to follow. FIG. 3e again includes content place holders 345, 350, 355, and 360 in this case videos at content place holders 350 and 360 still remain but the content place holder 345 has been replaced with a survey. The present invention determines whether or not the user has carried out the survey and/or watched the videos in content place holders 350 and 360, whether or not they have skipped any pages, whether they have exited the document before it finished. In the case of a survey, clicking of finish button, the user moving to another page, an audio trigger, a timer mechanism, or the user exiting the document may indicate completion of the survey.

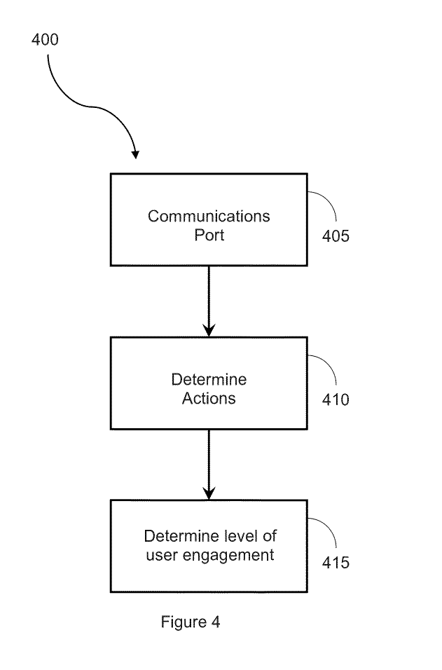

FIG. 4 illustrates a method 400 for analysing the level of user engagement within an electronic document according to an embodiment of the invention. At step 405 an electronic document is displayed to a user, the electronic document having one or more pages such as that shown in FIGS. 3a to 3e. The electronic document includes a graphical user interface for navigating the electronic document and the electronic document includes one or more content place holders associated with the pages for displaying content within the place holder. The place holders may provide content such as a video clip, graphics, an animation, text, a game, a questionnaire and the like.

Once the document is being viewed by a user control moves to step 410 where during the user's engagement with the electronic document it is determined whether one or more actions have been carried out within the electronic document. The system determines that the document is being viewed by a trigger such as a ‘click on link’ which may trigger a notification sent to the server that viewing is ‘in progress’ . . . (or in the aggregate, how many people are currently viewing the document for a one to may type of document such as a marketing campaign) together with real time updates as to events which occur such as a page turn, link click, or typing an answer. Real time changes in engagement levels could even alter pre-set variations in content or outcomes. The one or more actions may include actions which are carried out within the one or more content place holders or maybe the absence of an action such as allowing the electronic document to automatically play and turn pages automatically. In addition, the action may include engaging with the graphical user interface—for example fast forwarding or skipping a page before it has completed. Control then moves to step 415 in which the level of user engagement is determined based upon the one or more actions carried out during the display of the electronic documents. The level of user engagement may be determined by aggregating one or more of the actions carried out by the user during the viewing of the document. For example a score may be generated (out of 100, or graded A,B,C . . . or ‘star ranking’ or the like) or the content creator may choose how to rank importance of actions based on their own preferences. Particular pages may for example carry a greater weighting if a document was exited at that particular page than any other page. In an alternative, the extent to which a page or document has been shared via social media may increase the ranking (or more weight may be placed on this action) in determining an overall score.

The action records may, in suitable implementations, record a wide variety of possible actions or steps, or sequences of those steps. Implementations of the present invention are not limited to any specific actions, and the factors recorded are a function of the code written and the specific requirements of the site and owner. Examples includes one or more of: the point at which a document was terminated; how many pages were viewed before the document was terminated; whether or not a page turn was a user initiated page turn; whether or not a page turn was non-user initiated page turn; the length of time spent on a page; whether or not there was a page turn back to a previous page, the length of time spent viewing a particular content placeholder; whether the electronic document paused; whether the volume was turned up or muted; the number of page views by the user; which content placeholders were engaged with; whether content within a content placeholder was viewed; and whether a page was forwarded by email or social media.

Preferably, the overall score is an aggregate of a multiplicity of weighted engagement measurements that likely would be derived from a predetermined scale or weighting. Since pages associated with the electronic document are multi modal in length that includes time, the present invention can offer a greater multiplicity of measurements that have not been available previously.

Preferably, the author may view the analytics via a dashboard or may be sent alerts sent via email, text etcetera. Preferably, the analytics are captured in real time and updated every few minutes. This may be likened to a social media application so that the author knows their reader is currently reading it. For example, a financial consultant authors an electronic document for a client and is alerted that they are viewing it. They could then view the analytics and call the client a few seconds later while the information is still fresh in their mind and also know precisely what areas they are interested in/clicked on, etcetera.

As an example of aggregating one or more actions within a document to determine an overall level of engagement, a media company may auto generate personalised ‘news films’ with multi-layered stories and advertising inside of it whereby alerts are to be sent to journalists if their stories generate over a 60% exit rate by page 2 or if any portions of their article have a ‘greater than 40% early page turn rate’ so that they could edit or tighten the piece in real time and update it accordingly. aUsing a scale of 1 to 100; reaching the last page would have a 20% weighting, total seconds spent in the document a 10% weighting, clicking on the adjoining advertisement a 25% weighting, sharing via social media a 35% weighting and ‘liking’ or commenting at 5% each. Hence, the top score of 100 would be achieved if a viewer reached the end without any premature page turns and clicked on the advertisement along with a ‘like’ button and shared it via social media while also inputting a comment. A more moderate score of 60 would accrue from viewing ¾ of the document (15 points) before exiting while turning the page on average after only ½ of the content has finished (5 out of 10 points) without clicking on the advertisement (0 points) but having shared the document (35 points) and ‘liking’ it (5 points) without writing any comments. Engagement data/scores can be analysed on an individual basis or in the aggregate/context of a mass mailing to thousands or millions of clients. A data merge mailed out to many thousands of clients can still yield a unique URL for each recipient thereby allowing automated personalisation along with further individual examination of analytics.

The measurement or scaling may vary in electronic documents used in marketing or advertising (political or commercial advertising) compared to an electronic document for education, a survey, or instruction manual, etcetera. In the context of advertising the number of social media shares may be weighted higher than viewing the last page. Or in another campaign with an image, textual, QR code, bar code, or link based coupon inside the document, the rate of data input or redemption rate may have a greater weighting.

In an alternative, the actions carried out by the user may simply be reported and recorded so that the creator of the electronic document can determine the level of engagement with the document and in particular, for example a particular page in the document. It may be for example, that many users who view the document exit on page three and the electronic document may be therefore updated to provide a page three which is more interesting to better engage the user. In another alternative, it may include a page where viewers often turn the page before it has finished indicating to the creator to shorten the imagery, text, or video portions on this page.

The one or more actions recorded may include the point in which a document was terminated by the graphical user interface, how many pages within the electronic document were viewed before the electronic document was terminated, whether or not a page turn was a user initiated page turn, whether or not a page turn was a non-user initiated page turn (i.e. an automatic page turn associated with the electronic document), the length of time a user spent on a page which may be measured by a timer, whether or not there was a page turn back to a previous page, the length of time spent viewing a particular content page holder. For example, a page may include numerous content place holders one of which may include a video. It may be determined that a user has or has not watched the video within the content place holder but has watched or viewed another content place holder within the particular page. This may be determined by providing retina monitoring, requesting a mouse over by the user on to the content place holder determining whether or not this has been carried out and reporting. Other actions may include the number of page views by the user, which particular content place holders within the page where engaged with, for example, whether they were clicked on, whether there was an input to a questionnaire which was presented to the user. Determining which content place holder the user focused on within the page during the display of the page. This may be determined via a retina monitor or by sensing voice commands. Also a further action may include whether or not the page or the electronic document itself was forwarded via email or social media. Or whether or not a particular hyperlink was clicked on in the page. Preferably the one or more actions are aggregated so as to determine the level of engagement of a user.

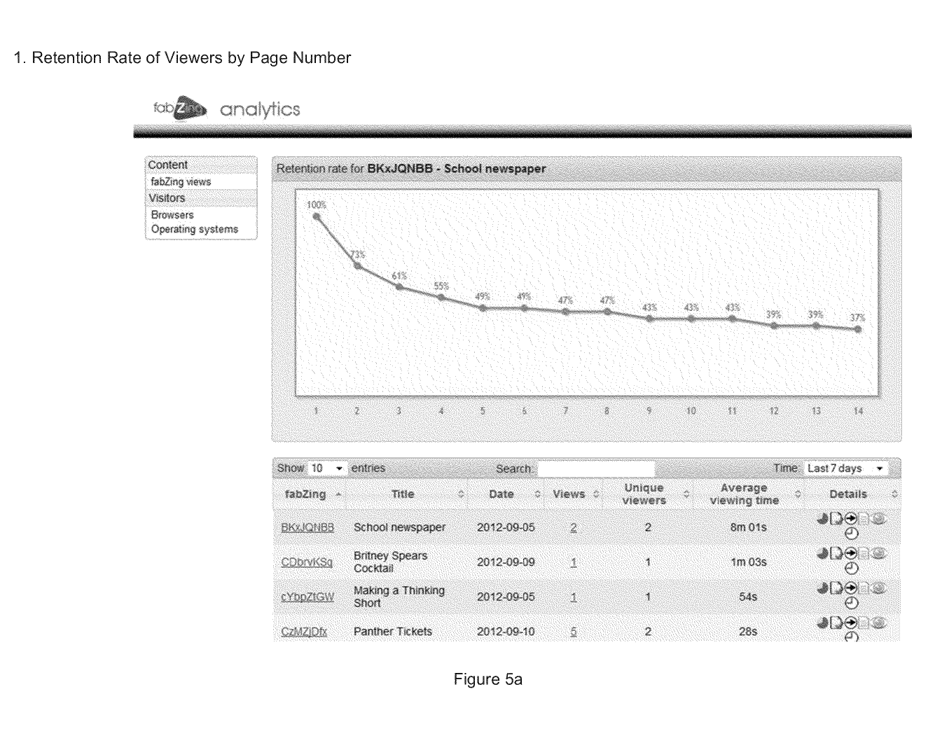

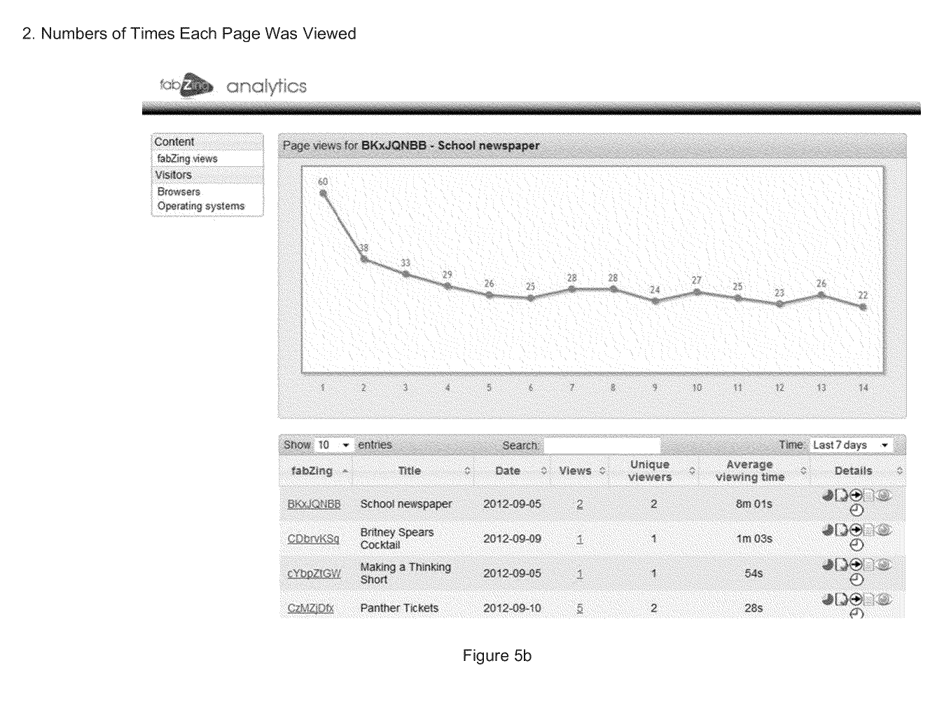

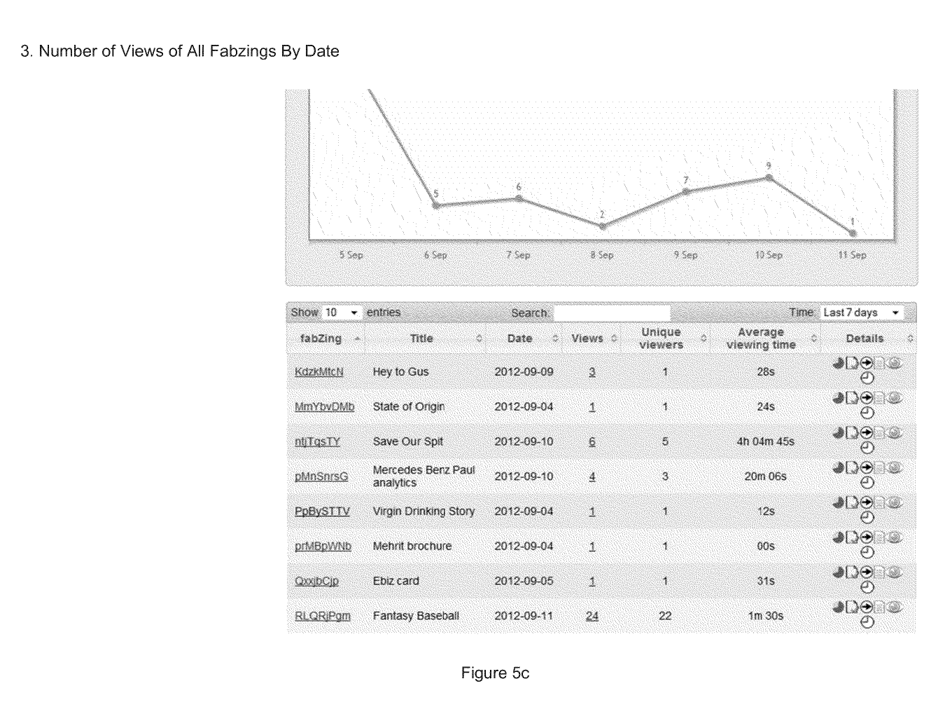

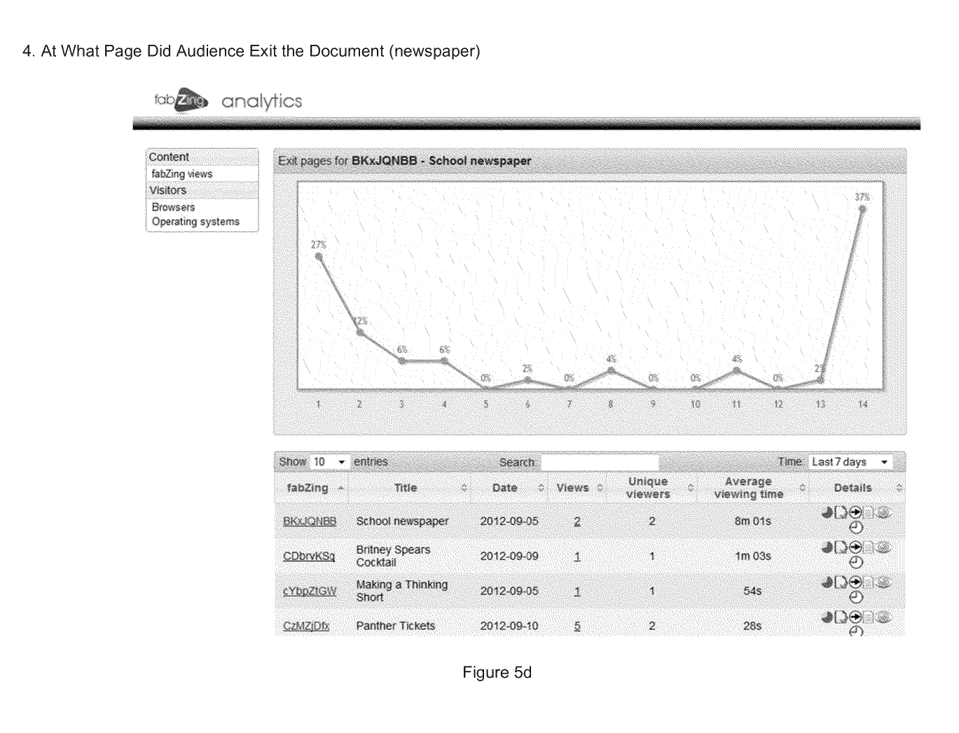

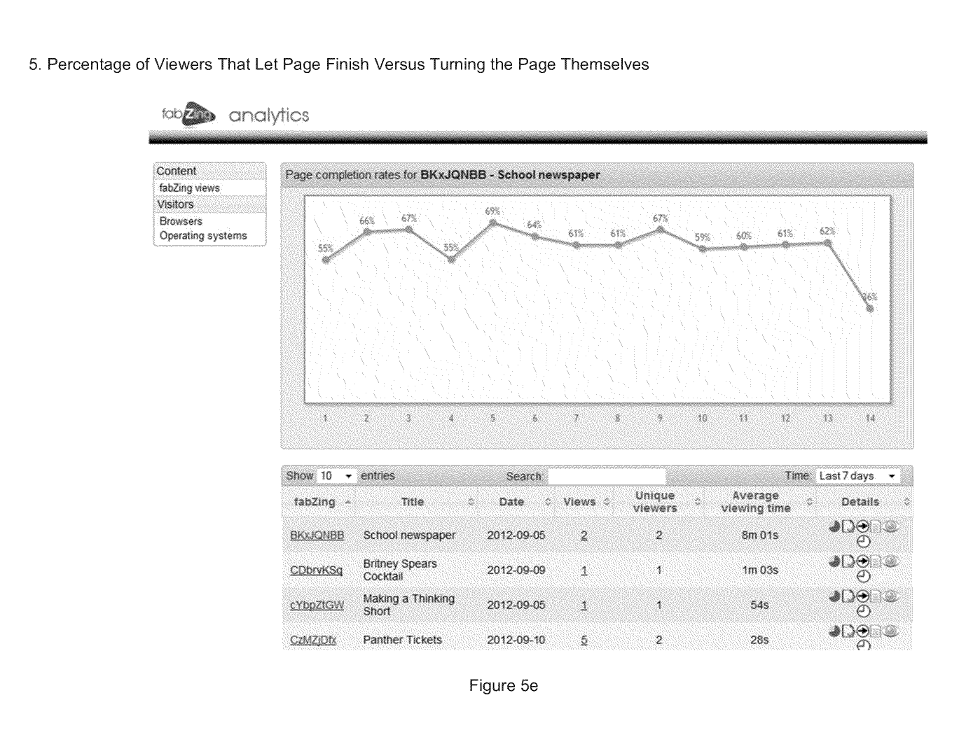

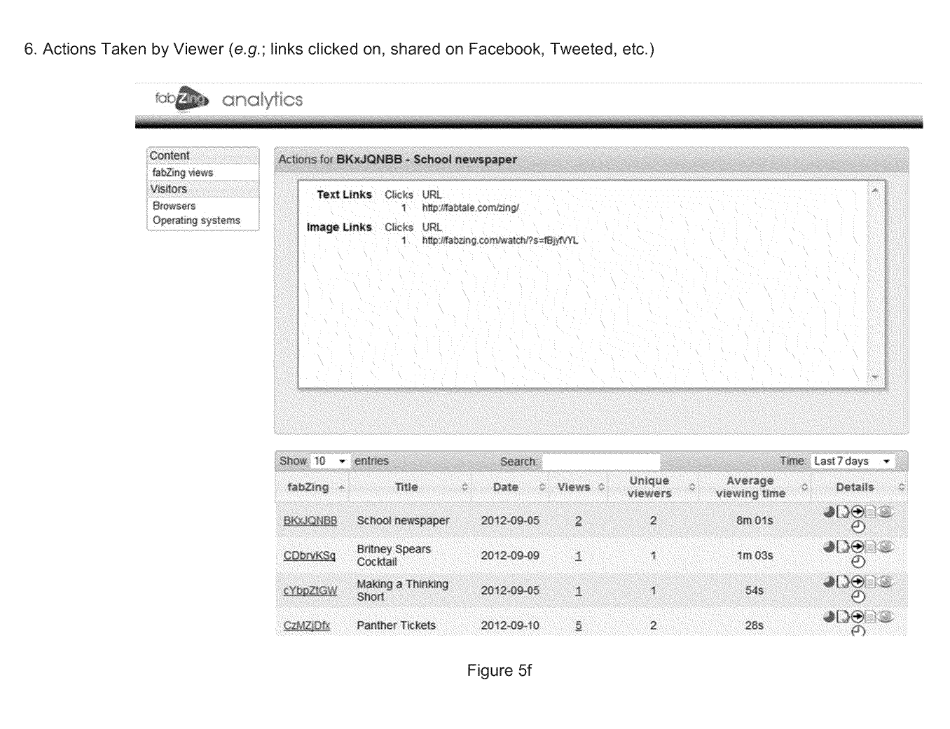

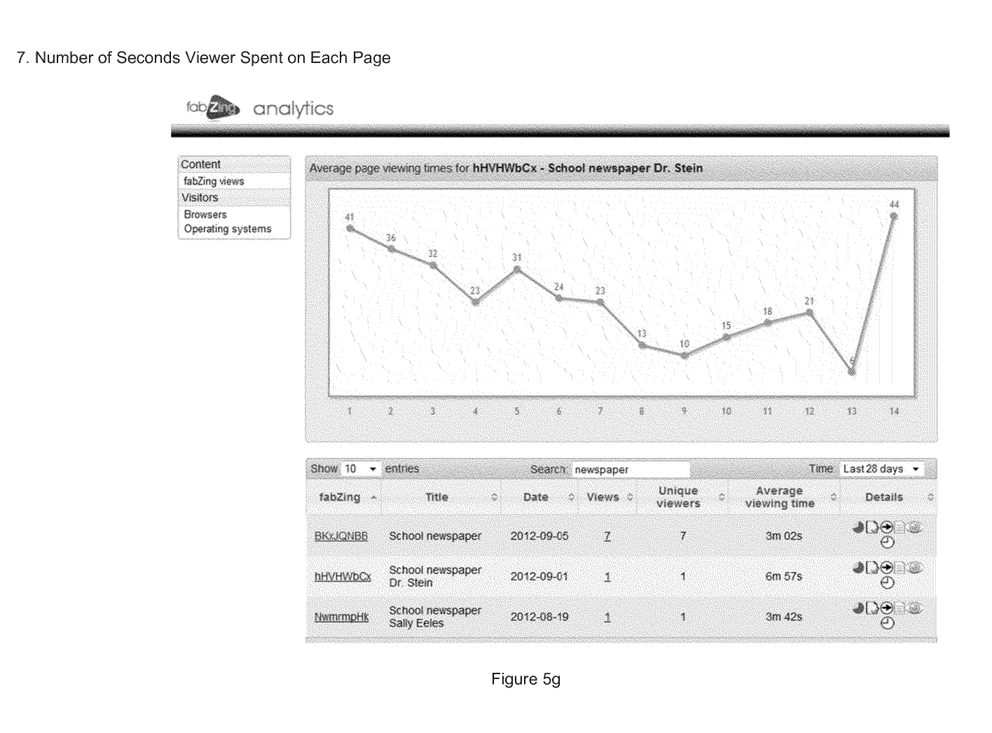

FIGS. 5a to 5g show screen shots of analytics for the electronic document provided in FIGS. 3a to 3e. In this regard, the electronic document is a 14 page sample newspaper with news and video and text and sound on one or more content place holders over 14 pages. Each of the pages has a particular duration and a number of content place holders within it. FIG. 5a illustrates the retention rate of viewers by page number which provides the document creator with an indication as to how many pages the average viewer watched for example it is clear that the first page was viewed by 100 percent of the viewers and this drops off to 73 percent on the second page, 61 percent on the third page and so on until 37 percent on the fourteenth page. Each of the pages also has a number of views together with the number of unique viewers of the page and the average viewing time of the page. This may be determined over a time period such as the last seven days as shown in FIG. 5a. Advantageously this metric may allow the creator of the electronic document to consider whether the document is too long or making sure pages 3 onwards are engaging so as to maintain the user reading the electronic document.

FIG. 5b is metric determining the number of times each page in a particular electronic document was viewed and in this case it can be seen for example that the first page was viewed the most times, followed by the second page and another spike between pages 6 through 8. It may be that the user viewing the electronic document has elected to skip to page 7 for example while having watched pages 1 and 2 (or the user is replaying this page or skipping back to it). FIG. 5c shows a metric illustrating a number of views of the overall electronic document by date.

FIG. 5d the metric determining at what point did the user exit the document by closing down the electronic document. It is clear from the analytics in the case of the example people either exited on the first page generally or viewed the document through to the last page on page 14. This metric may give the document creator insight into the content of the page between 2 and 13 being satisfactory but perhaps the first page requiring more interesting content for example. FIG. 5e is a metric illustrating the percentage of viewers that let a particular page within the electronic document complete rather than turning the page manually via the graphic user interface. It can be seen that certain pages such as pages 1 and 4 had a lower percentage of people waiting rather than say, for example pages 5 and 9. The creator of the document can then consider the reasons why this might be the case such as the length of the display of the page and consider shortening it or improving the content of the page. FIG. 5f illustrates a screen shot of a metric showing action taken by a user within the electronic document and advises whether or not they have clicked on links within the electronic document or whether they have shared the electronic document or links within the electronic document to other users such as via Facebook™, twitter™ and other social media.

FIG. 5g illustrates a screen shot showing a metric for measuring the average number of seconds the user spent on each particular page of the electronic document. For example, the average time on page 1 was 41 seconds, page 2 was 36 seconds, etcetera. The metric may include page replays of the page in the average. If the example was measuring a ‘one to one’ document (i.e. a document sent from one person to another) the creator of the document could see that the recipient turned page 3 after 32 seconds (even though the full page lasts 41 seconds) which would inform the creator that although the recipient did not let the page complete, they still viewed it for 32 seconds. Alternatively, if the recipient viewed the page for 94 seconds (which may be considered to be an inordinate amount of time for that page) but the page has not been viewed more than once, then it may be that the recipient has paused the document and for example answered the phone before continuing to the end of the document before exiting.

A further metric may include the rate of change of any combination of measurements over a particular time period to help determine what may be trending or a rate of improvement/decline in the analytics of a particular document's engagement level. For example, an engagement level increase (e.g., a hypothetical score of +21) could develop from high social media sharing leading to more like minded individuals or interest groups viewing (think political party affiliations, sports groups, or hobby interests) which would in turn lead to increased viral sharing and targeted recipients. This would be beneficial in determining the effectiveness of changes made by the creator, or in the absence of such changes determining what influences, patterns, or changes are occurring outside the data set.

In addition to the above, comparative engagement analysis may be done between various social media sites. For example, using the same electronic document spread evenly over a number of different social media sites may yield quite different degrees of engagement. For example a Facebook view in Australia versus a Twitter link in England and a Pinterest view in Florida.

Optional embodiments of the present invention may also be said to broadly consist in the paths, elements and features referred to or indicated herein, individually or collectively, in any or all combinations of two or more of the paths, elements or features and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1. A method for automatically analysing the level of user engagement within an electronic document, including the steps of:
displaying an electronic document having one or more pages, the document including a graphical user interface and one or more content placeholders associated with the pages for displaying content within the placeholder;
determining whether the user has carried out one or more actions within the electronic document; and
responsive to the one or more actions, automatically determining the level of user engagement.

2. A method according to claim 1, wherein the actions are carried out within the one or more content placeholders.

3. A method according to claim 1, wherein the content placeholder includes content in the form of one or more of: a game, a questionnaire, an image, a video clip, text, a sound, music, a photograph, a smell or an animation.

4. A method according to claim 3, wherein the actions are associated with the graphical user interface.

5. A method according to claim 1, wherein an action includes any one or more selected from the group comprising: providing an input to a prompt provided by the one or more content placeholders; moving a cursor over the one or more content placeholders; providing or recording an eye movement or blink; making a hand gesture; and providing voice input.

6. A method according to claim 1, wherein the action records one or more of the point at which a document was terminated; how many pages were viewed before the document was terminated; whether or not a page turn was a user initiated page turn; whether or not a page turn was non-user initiated page turn; the length of time spent on a page; whether or not there was a page turn back to a previous page, the length of time spent viewing a particular content placeholder; whether the electronic document paused; whether the volume was turned up or muted; the number of page views by the user; which content placeholders were engaged with; whether content within a content placeholder was viewed;
and whether a page was forwarded by email or social media.

7. A method according to claim 1, further including the step of aggregating the one or more actions to determine a level of user engagement.

8. A software product for use with a computer including a processor and associated memory device for storing the software, the software for providing an electronic document to a user, the electronic document having one or more pages and one or more content placeholders associated with the pages, the software including a series of instructions to cause the processor to carry out the steps of:
displaying an electronic document having one or more pages, the document including a graphical user interface and one or more content placeholders associated with the pages for displaying content within the placeholder;
determining whether the user has carried out one or more actions within the electronic document;
determining the level of user engagement based on the one or more actions.

9. A computer readable media containing software for use with a computer including a processor and associated memory device for storing the software, the software for providing an electronic document to a user, the electronic document having one or more pages and one or more content placeholders associated with the pages, the software including a series of instructions to cause the processor to carry out the steps of:
displaying an electronic document having one or more pages, the document including a graphical user interface and one or more content placeholders associated with the pages for displaying content within the placeholder;
determining whether the user has carried out one or more actions within the electronic document;
determining the level of user engagement based on the one or more actions.

10. An apparatus for providing an electronic document to a user, the electronic document having one or more pages and one or more content placeholders associated with the pages, the apparatus including:
a processor,
a memory,
a user interface including an input device and an output device, and
a software program resident in memory accessible to the processor, the program executable by the processor to carry out the steps of:
displaying an electronic document having one or more pages, the document including a graphical user interface and one or more content placeholders associated with the pages for displaying content within the placeholder;
determining whether the user has carried out one or more actions within the electronic document;
determining the level of user engagement based on the one or more actions.

11. A method according to claim 2, wherein the content placeholder includes content in the form of one or more of: a game, a questionnaire, an image, a video clip, text, a sound, music, a photograph, a smell or an animation.

12. A method according to claim 2, wherein an action includes any one or more selected from the group comprising: providing an input to a prompt provided by the one or more content placeholders; moving a cursor over the one or more content placeholders; providing or recording an eye movement or blink; making a hand gesture; and providing voice input.

13. A method according to claim 3, wherein an action includes any one or more selected from the group comprising: providing an input to a prompt provided by the one or more content placeholders; moving a cursor over the one or more content placeholders; providing or recording an eye movement or blink; making a hand gesture; and providing voice input.

14. A method according to claim 4, wherein an action includes any one or more selected from the group comprising: providing an input to a prompt provided by the one or more content placeholders; moving a cursor over the one or more content placeholders; providing or recording an eye movement or blink; making a hand gesture; and providing voice input.

15. A method according to claim 2, wherein the action records one or more of the point at which a document was terminated; how many pages were viewed before the document was terminated; whether or not a page turn was a user initiated page turn; whether or not a page turn was non-user initiated page turn; the length of time spent on a page; whether or not there was a page turn back to a previous page, the length of time spent viewing a particular content placeholder; whether the electronic document paused; whether the volume was turned up or muted; the number of page views by the user; which content placeholders were engaged with; whether content within a content placeholder was viewed; and whether a page was forwarded by email or social media.

16. A method according to claim 3, wherein the action records one or more of the point at which a document was terminated; how many pages were viewed before the document was terminated; whether or not a page turn was a user initiated page turn; whether or not a page turn was non-user initiated page turn; the length of time spent on a page; whether or not there was a page turn back to a previous page, the length of time spent viewing a particular content placeholder; whether the electronic document paused; whether the volume was turned up or muted; the number of page views by the user; which content placeholders were engaged with; whether content within a content placeholder was viewed; and whether a page was forwarded by email or social media.

17. A method according to claim 4, wherein the action records one or more of the point at which a document was terminated; how many pages were viewed before the document was terminated; whether or not a page turn was a user initiated page turn; whether or not a page turn was non-user initiated page turn; the length of time spent on a page; whether or not there was a page turn back to a previous page, the length of time spent viewing a particular content placeholder; whether the electronic document paused; whether the volume was turned up or muted; the number of page views by the user; which content placeholders were engaged with; whether content within a content placeholder was viewed; and whether a page was forwarded by email or social media.

18. A method according to claim 5, wherein the action records one or more of the point at which a document was terminated; how many pages were viewed before the document was terminated; whether or not a page turn was a user initiated page turn; whether or not a page turn was non-user initiated page turn; the length of time spent on a page; whether or not there was a page turn back to a previous page, the length of time spent viewing a particular content placeholder; whether the electronic document paused; whether the volume was turned up or muted; the number of page views by the user; which content placeholders were engaged with; whether content within a content placeholder was viewed; and whether a page was forwarded by email or social media.

19. A method according to claim 2, further including the step of aggregating the one or more actions to determine a level of user engagement.

20. A method according to claim 3, further including the step of aggregating the one or more actions to determine a level of user engagement.
